(19) United States
(12) Patent Application Publication
(10) Pub. No.: US 2008/0282156 A1
(43) Pub. Date: Nov. 13, 2008

(54) METHOD AND SYSTEM FOR PROVIDING A SLIDESHOW TO MULTIPLE PLATFORMS

(75) Inventors: Jason Skicewicz, Honolulu, HI (US); Lorenz Sell, Honolulu, HI (US); Henk Rogers, Honolulu, HI (US); Chad Podoski, Honolulu, HI (US); Nesan Waran, Honolulu, HI (US); George McBay, San Diego, CA (US)

Correspondence Address: STRATEGIC PATENT GROUP, P.C., P.O. BOX 1329, MOUNTAIN VIEW, CA, 94042, US

(73) Assignee: Blue Lava Technologies, Inc., Honolulu, HI (US)

(21) Appl. No.: 12/117,751

(22) Filed: May 9, 2008

Related U.S. Application Data
(60) Provisional application No. 60/917,320, filed on May 10, 2007.

(51) Int. Cl. G06F 3/14

(52) U.S. Cl. 715/273

(57) ABSTRACT

A computer-implemented method and system for displaying multimedia content on a device corresponding to a platform are described. The multimedia content includes a plurality of items. The method and system include determining at least one attribute associated with an item of the plurality of items. The method and system also include placing the item in a cluster based on the attribute(s) and without requiring user-selection of the item. The cluster includes at least a portion of the items. The method and system further include rendering a slideshow of the cluster as a formatted slideshow. The formatted slideshow corresponds to the platform. The method and system further include providing the formatted slideshow to the device for display.

### CROSS-REFERENCE TO RELATED APPLICATIONS

This application claims priority from co-pending Provisional Patent Application Ser. No. 60/917,320, filed May 10, 2007, entitled “METHOD AND SYSTEM FOR PROVIDING A VIDEO FEED OF A SLIDESHOW TO MULTIPLE PLATFORMS, assigned to the assignee of the present invention.

### BACKGROUND OF THE INVENTION

Managing content, including but not limited to multimedia content such as video and image data, continues to be a challenge. For example, an enormous number of digital photos (photos) are taken by individuals each year. The majority of such photos sit dormant on users' computers without being organized, shared or displayed. Further, users continue to add to their multimedia content. Users may obtain syndicated content, such as digital photos (photos), via a feed. For example, such content may be provided to users through well-known mechanisms such as a really simple syndication (RSS) feed or other XML feed. Once the user receives the content from the feed, the user can view the photos or other content. Content may also be received from other users who share their photos or other multimedia content. A user may also continue to generate their own content, for example by continuing to take digital pictures or video. Other sources of multimedia content are also available.

A user's multimedia content may be desired to be viewed for a number of reasons. The user may wish to view certain content, for example photos for personal reasons. A user may also wish to share the photos with others. Conventional sharing of photos or other content may take place via a variety of mechanisms. For example, a user may email individual photos to others or post the photos to a site that is accessible by others.

One conventional mechanism for displaying multimedia content in the form of photos is a conventional slideshow. FIG. 1 depicts a conventional method 10 for displaying photos, for example photos in digital format, in a slideshow. The user individually selects the photos to be shown in the slideshow, via step 12. In addition, users may select other preferences for the slideshow parameters, such as the time each photo is displayed, via step 14. The photos are displayed in series in the slideshow, via step 16. Each of the photos is depicted for a limited time in step 16. In addition, step 16 may play music or other sound during the slideshow. The conventional method 10 may be performed on a user's computer system only, for example via a desktop application. Alternatively, the conventional method 10 may be performed via a remote site accessed, for example, using the Internet. In some conventional sites, authorized users can view and comment on the slideshow created by the owner. The slideshow may also be saved to a file, which the user emails to friends and relatives or posts to a site.

Although the conventional method 10 functions, one of ordinary skill in the art will recognize that there are drawbacks. The conventional method 10 is typically tedious and requires the user to set many parameters of the slideshow including but not limited to the photos in the slideshow. Because the conventional method 10 is tedious, a user may be less likely to view the stored photos. As a result, a user is less able to determine what content they have access to, whether they value the content, whether some of the stored content should be deleted, and to share the desired content with others. Furthermore, the slideshow itself may be difficult to view for a number of reasons. For example, the slideshow may be provided to other users who are unable to view the slideshow for some reason. Accordingly, what is desired is an improved method and system for viewing and/or sharing multimedia content.

### BRIEF SUMMARY OF THE INVENTION

A computer-implemented method and system for displaying multimedia content on a device corresponding to a platform are described. The multimedia content includes a plurality of items. The method and system include determining at least one attribute associated with an item of the plurality of items. The method and system also include placing the item in a cluster based on the attribute(s) and without requiring user-selection of the item. The cluster includes at least a portion of the items. The method and system further include rendering a slideshow of the cluster as a formatted slideshow. The formatted slideshow corresponds to the platform. The method and system further include providing the formatted slideshow to the device for display.

According to the method and system disclosed herein, the present invention provides a mechanism for automatically displaying multimedia content to a user.

### BRIEF DESCRIPTION OF SEVERAL VIEWS OF THE DRAWINGS

FIG. 1 depicts an exemplary embodiment of a method for providing a slideshow.

FIG. 2 depicts an exemplary embodiment of a method for providing a slideshow for a particular platform.

FIG. 3 depicts an exemplary embodiment of a system for providing a slideshow for a particular platform.

FIG. 4 depicts another exemplary embodiment of a method for providing a slideshow.

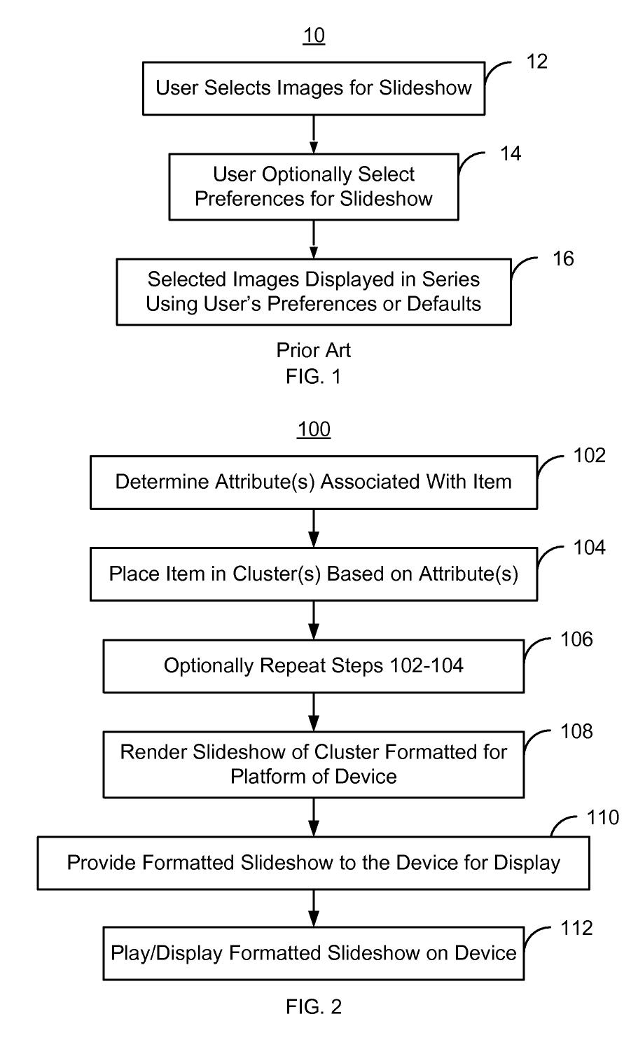

### DETAILED DESCRIPTION OF THE INVENTION

The present invention relates to managing of multimedia content. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A computer-implemented method and system for displaying multimedia content on a device corresponding to a platform are described. The multimedia content includes a plurality of items. The method and system include determining at least one attribute associated with an item of the plurality of items. The method and system also include placing the item in a cluster based on the attribute(s) and without requiring user-selection of the item. The cluster includes at least a portion of the items. The method and system further include rendering a slideshow of the cluster as a formatted slideshow. The formatted slideshow corresponds to the platform. The method and system further include providing the formatted slideshow to the device for display.

The method and system are mainly described in terms of particular systems provided in particular implementations. However, one of ordinary skill in the art will readily recognize that this method and system will operate effectively in other implementations. For example, portions of the method and system may be described in the context of a desktop system and/or a remote system, which may be accessed through a network such as the Internet. However, one of ordinary skill in the art will recognize that the method and system may be utilized in other systems. For example, portions described in the context of a desktop system might be used in a network, for example the Internet, or vice versa. Thus, the systems, devices, and networks usable with the method and system can take a number of different forms. The method will also be described in the context of certain steps. However, the method and system operate effectively for other methods having different and/or additional steps not inconsistent with the present invention. Further, the steps in the method may be performed in a different order, including in parallel. The steps of the methods described herein may also be performed at very different times. Stated differently, the methods described herein need not be performed on the fly. In addition, although the method and system may be described with respect to single items, one of ordinary skill in the art will recognize that the method and system also operate effectively for multiple items. In addition, the method and system are described in the context of multimedia items, such as photos. As used herein, an item of multimedia content includes at least one photo. In some embodiments, multiple photos, for example a video clip, sound, and/or other content may also be part of the item. One of ordinary skill in the art will also recognize that although multimedia content includes photos, the method and system may be used for other multimedia content, such as video clips.

FIG. 2 depicts an exemplary embodiment of a method 100 for providing a slideshow capable of being shown on a desired device corresponding to particular platform(s). In one embodiment, the method 100 may be utilized to display a slideshow of images which the device would otherwise not be able to display. Further, in one embodiment, the device is remote from the system (not shown in FIG. 2) which implements the method 100. For clarity, the method 100 is described in the context of items of multimedia content. In one embodiment, such items include photos. The photo(s) may have visual content as well as other multimedia content. For example, the photo(s) might include a digital image that has been annotated with sound. The items might also include other multimedia content, such as sound and/or video clips. Such other multimedia content may be incorporated with the photos in the method 100. In one embodiment, the source of the multimedia content includes a feed, such as an RSS or other XML feed. However, in another embodiment, the source of the multimedia content may be different. For example, the items may simply include a user's multimedia collection, such as the user's photos.

The attributes associated with an item are determined, via step 102. The attributes might include user-added metadata, temporal attributes, geographic attributes, subject attributes that correspond to person(s) in the item, object(s) of interest in the item, region(s) of interest in the items, post-capture attribute(s), and image quality attribute(s). Temporal attributes may include the timestamp of a photo, a window of time around the timestamp, or another time the user has associated with the item. Geographic attributes may include geographic data such as global positioning satellite (GPS) data, particular landmarks, or other analogous data. Image quality attribute(s) may include whether the photos is in focus, whether specific portions of the photo or specific individuals in the photo are in focus, whether the photo substantially duplicates another photo, or some other indicator of image quality. Post-capture attributes might include the item popularity and other attributes related to the item. Item popularity may, for example, be expressed by the number of votes for the photos, the amount of time a user has spent viewing the photo, the number of times the user has shared the photo, the number of times other individuals shared the photo, whether a user or other individual has upgraded or downgraded a photo for inclusion in or exclusion from a slideshow, and/or other like measures of the individual's preferences.

The subject attributes corresponding to persons may include whether there are persons in the photo, the identities of persons in the photo, and the relationship of the persons in the photo to the user. In one embodiment, facial detection and recognition may be used for determining whether there are persons in the photo and the identity of such persons. In another embodiment, a user may indicate the identity of a person and/or detect that there are persons(s) in the item. The relationship of persons in the photo to the user may take into account whether the user or individual(s) close to the user appear in the same photo as individuals in the photo, how often the user appears with individual(s) in the photo, whether individuals in the photo appear at the same event as the user, whether the user has additional information such as address information for the individual, whether the user and individual have shared other photos, and/or other measures of how close a relationship the individual has with the user. In one embodiment, each time another individual meets some criteria, for example appearing in a photo or provides an item to the user's multimedia collection, an additional link in a graph is provided between the user and the individual. The more links between the user and a particular individual, the closer the relationship between the individual and the user. Items of multimedia content having to do with an individual that is more closely related are more likely to be included in a slideshow, as described below. Note that the determination of the attributes in step 102 may involve some user participation, for example in identifying an individual in a photo, choosing to share a photo, or viewing a photo. However, a number of the attributes are calculated with limited or no user input. For example, geographic data may require no specific input from a user. Similarly, the determination of a relationship or popularity of an item employs user input in its calculation, but may be automatically determined by a system implementing the method 100.

The item is placed in a cluster based on the attributes, via step 104. For example, photos that are all determined to be related to the same event based upon GPS or other geographic data in conjunction with time stamps and/or the individuals in the photos may all be placed in the same cluster. Photos of particular individuals may be placed in another cluster. Note that a single item may be placed in more than one cluster. In one embodiment, step 104 is performed automatically without any additional user input. In another embodiment, the user may specifically place the item in the cluster(s).

The steps of determining the attributes of the items of multimedia content and placing the content in clusters are repeated, via step 106. Thus, through steps 102, 104, and 106, some or all of the user's multimedia may be analyzed and grouped into clusters. For similar reasons to those discussed above, step 106 may be performed automatically without the user having to perform any additional tasks. In another embodiment, the user may perform some tasks, such as identifying individuals in photos. The placement of the items in the appropriate cluster is, however, preferably carried out automatically by computer system(s). In another embodiment, the user may place some or all of the items in the appropriate cluster.

A slideshow of the items in one or more of the clusters is rendered in format(s) appropriate for the device(s) on which the slideshow is desired to be viewed, via step 108. For example, a user may desire to view the slideshow on their own desktop, as well as on their iPod®, AppleTV™, game console such as a Nintendo®Wii™, or TiVo® and may desire to share the slideshow with others. In step 108, therefore, a slideshow of the cluster formed in steps 104 and 106 is rendered in the format(s) for the desired platforms. In one embodiment, step 108 includes generating a slideshow. Thus, the parameters for the slideshow may be set. The parameters may includes the order of the items in the cluster, whether specific items might be discarded for example because they are duplicates of or similar to other items in the cluster, the display time for the items in the slideshow, whether and how much panning is to be employed, how transitions between items are to be handled, and/or other parameters. Generation of the slideshow may thus include features such as upgrading, downgrading, or excluding photos for a slideshow, selection of photos having to do with a particular individual, and/or control over parameters of the slide show. For example, if the slideshow employs panning, facial detection may be used to define the locations of the faces so that panning is performed such that faces remain visible. Similarly, facial recognition may be used to determine how to place items in the slideshow. For example, items may be ordered to separate people from showing up in the show two times in a row. Individuals may be spaced out by controlling the frequency in which items in which they appear are shown. Similarly, subject attributes may be used to space out groups containing a certain number of people. For example, items including a particular number of persons—four people, three people, or ten people—may be upgraded or downgraded so that items in which a large number are not shown subsequently. Additionally the number of people in a photo may be used to guide the duration upon which that particular photo is shown to the user. For example, an item having more people in the photo may be shown for a greater or smaller time. For the user's own desktop system, the slideshow may simply be displayed or may be saved as a file, such as an MP4 and played. In addition, the slideshow may be rendered as a podcast and/or video to be made available to the iPod®, AppleTV™, game console such as a Nintendo®Wii™, TiVo®, and/or other devices. These and other formats may be used to provide the slideshow to other devices having other platforms such as mobile phones, personal computing devices and/or other devices that may display multimedia content.

The formatted slideshows are provided to the desired device(s) for display, via step 110. In step 110, the slideshow, generated in the platform appropriate format such as MP4, may simply be played on the user's desktop. In addition, the MP4, video, or podcast or other formatted slideshow might be uploaded to a server accessible by the desired devices. The formatted slideshow appropriate for the devices might be pushed to the desired device(s) or pulled by the desired device(s). Consequently, the slideshow is provided in the appropriate format for the platform of each of the desired device(s) on which the slideshow is to be played. The formatted slideshow may be shown on the display of the device, via step 112.

Thus, using the method 100, a slideshow of a user's content may be automatically generated in the format(s) appropriate to multiple devices on which the slideshow is desired to be viewed. In one embodiment, one or more of the devices may be remote from the user's computer system and/or may belong to other individuals. Consequently, the users' ability to view and share their multimedia content is enhanced.

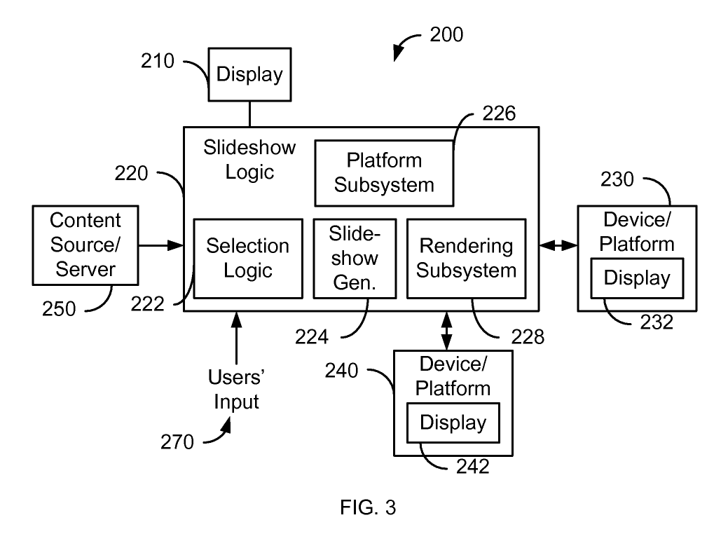

FIG. 3 depicts an exemplary embodiment of a computer system 200 for providing a slideshow capable of being shown on the desired platform(s). In one embodiment, the computer system 200 is entirely on a user's computer, or desktop system. However, in an alternate embodiment, one or more components of the system 200 may reside elsewhere and be remotely accessed. Also shown in FIG. 3 are a content source/server 250 and devices 230 and 240 on which a slideshow of the multimedia content is desired to be displayed. In one embodiment, the devices 230 and 240 are remote from the system 200. The devices 230 and 240 may correspond to different platforms and includes displays 232 and 242, respectively. In one embodiment, the content source/server 250 includes a feed, such as an RSS or other XML feed. However, in another embodiment, the source 250 may simply archive the photos. For example, the content source/server 250 may simply include a user's photo collection. In addition, although only one content source/server 250 is shown, multiple content sources may be used. In addition, users' input 270 is also shown. The users' input 270 may be used to allow a user to select photos specifically for inclusion in the slideshow, provide feedback on photos, view photos, rate photos, vote for photos or provide other input to the system 200. In one embodiment, the users' input 270 may be used to select some or all of the content from the content source/server 250.

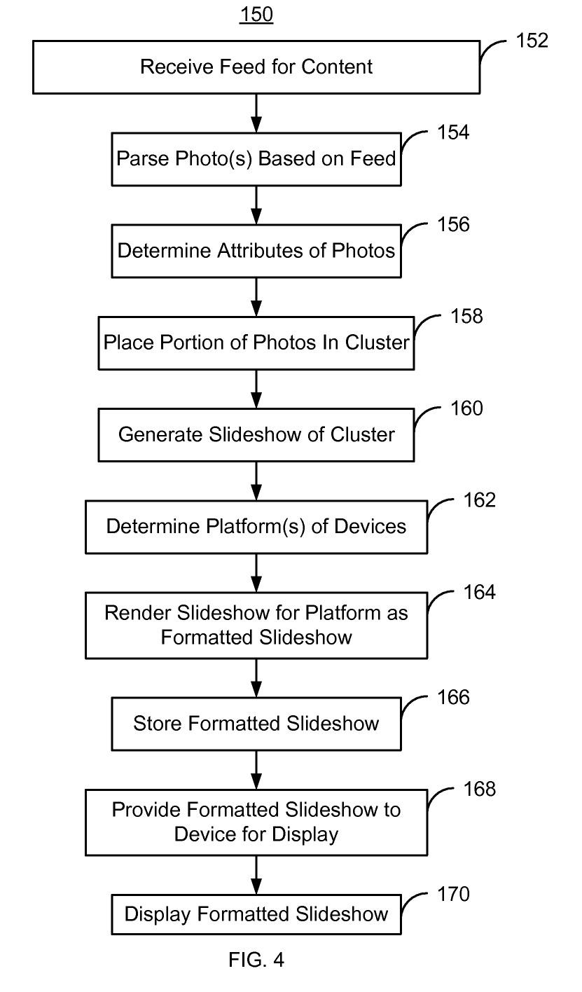

FIG. 4 depicts an exemplary embodiment of a method 150 for providing a slideshow capable of being shown on a desired device corresponding to particular platform(s). The method 150 is described in the context of the system 200 and devices 230 and 240. In one embodiment, the method 150 may be utilized to display a slideshow of images which the device(s) 230 and 240 would otherwise not be able to display. For clarity, the method 150 is described in the context of photos. However, the method 150 may be used with other items of multimedia content. The photo(s) may have visual content as well as other multimedia content. For example, the photo(s) might include a digital image that has been annotated with sound. Although not described with the method 150, other items of multimedia content, such as sound and/or video clips might also be included in the slideshow. However, in another embodiment, the method 150 and system 200 are used only for photos. Further, although described in order, steps in the method 150 may occur in another order. In addition, some steps may be combined or omitted.

Referring to FIGS. 3 and 4, the method 150 commences when at least some content is received from a feed, such as an RSS or other XML feed, via step 152. The feed may be received from the content source/server 250 or other feed. The content includes photos. Although the content is received as a feed, the content source/server 250 might not be a remote from the system 200. For example, in one embodiment, the feed may be obtained from another portion of a site or another portion of a user's computer system. The items are parsed based on the feed, via step 154. In one aspect, step 154 may include the user selecting which photos from the feed are to be included in the cluster and thus the slideshow. In another embodiment, the content may be parsed automatically. For example, the feed may be annotated. The data in the annotation may be used to break the feed up into specific chunks, such as individual photos.

Once broken into chunks, such as photos, the attributes of the multimedia content including that received from a feed are determined. In particular, the attributes associated with the photos are determined, via step 156. The determination of attributes is analogous to step 102, described above in FIG. 2. Referring back to FIGS. 3-4, step 156 may be performed using the slideshow logic 220 and more particularly, the selection logic 222. The photos are placed in one or more clusters based on the attributes, via step 158. Step 158 may also be performed using the selection logic 222. Step 158 is thus analogous to step 104. Consequently, the photos may be grouped into cluster(s) with little or no user input using the slideshow logic 220.

Slideshow(s) of the photos in one or more of the clusters is generated, via step 160. Step 160 may be performed by the slideshow generation subsystem 224. In one embodiment, the attributes determined in step 156 are used not only to place the photos in clusters, but also to generate the slideshow in step 160. For example, photos that are more popular may be placed earlier in the slideshow and/or displayed for a longer time. Photos that are duplicates, substantially similar to other photos, and/or taken in rapid succession with another photo may be omitted or displayed for a shorter time. In addition, the user's preferences may also be taken into account in generating the slideshow. The user's preferences may be accounted for using the attributes. For example, a photo which a user views for longer may be placed earlier in the slideshow. In another embodiment, the user may select other preferences for the slideshow, such as music to be played with the slideshow, or transitions between photos in the slideshow may be utilized when the slideshow(s) are generated. Similarly, step 160 may include utilizing facial detection (determining whether individuals' faces exist in the photo) and facial recognition (determining the identity of the individuals in the photo) software for determining whether there are people in the photo and who the people are. In such an embodiment, the photos may be preferentially selected to include people and/or to include certain people in the slideshow. Alternatively, depending upon the user's preferences, the photos may be preferentially selected to exclude people. Another criterion that may be used in automatically selecting photos may include the time the user viewed the photos, for example with a photo the user viewed longer being more likely to appear in the slideshow. The popularity of the photo provided in the feed, other metadata associated with the photo, the length of time that a user viewed a previous version of the slideshow or the feed, whether the user skipped particular photos, or other criteria may be used in selecting photos for the slideshow. Thus, the selection of photos in the slideshow, portions of photos in the slideshow, as well as other parameters for the slideshow may be determined in step 160.

The platforms for the desired devices are determined in step 162. In one embodiment, the user may indicate the devices to which the slideshow is desired to be provided. In another embodiment, the user may indicate individuals with whom the slideshow is desired to be shared. The system 200 may then determine the devices utilized by the individuals and determine the platforms based on these devices. Step 162 may be performed by platform subsystem 226. The subsystem 226 may include a database of individuals and their devices as well as devices and their corresponding platforms. Step 162 may then be performed by accessing this database to determine the desired platform(s). Step 162 may also include determining any limitations for the device 230 and 240 and their platform. For example, any limitations on the memory (not shown), processors (not shown) or resolution display 232 or 234 may be determined.

The slideshow generated in step 160 is rendered in format(s) compatible with the platforms of device(s) 230 and 240 on which the slideshow is desired to be viewed, via step 164. In step 164, therefore, the slideshow generated in step 160 may be rendered in another format. In one embodiment, step 160 generates the slideshow and stores the slideshow as an MP4 file. Step 164 may then include rendering the MP4 file as a podcast and/or video. Step 164 may also account for other limitations of the devices 230 and 240 and/or their corresponding platform. For example, a particular device 230 might have insufficient memory or other capacity to store the entire formatted slideshow. In such a case, step 164 might cull portions of the slideshow in order to ensure that the entire formatted slideshow can be stored by the device 230. This dropping of some content may be performed based on the attributes of the photos determined in step 156. For example, photos that are less popular, similar to other photos in the slideshow, or otherwise less desirable might be automatically removed until the formatted slideshow is sufficiently small that the formatted slideshow could be stored on available memory of the device 230. Step 164 might also choose to provide the formatted slideshow in another manner to account for the limitations of the device 230 or 240. For example, step 164 may ensure that the formatted slideshow will be provided by streaming portions of the slideshow to the device 230.

The formatted slideshow may then be stored, via step 166. For example, the video and/or podcast may be stored in local memory (not shown) or archived. The archiving might take place on memory for the system 200 or on a remote computer system. The formatted slideshow may then be provided to the device having the corresponding platform, via step 168. For example, a podcast and/or video may be provided to an iPod®, AppleTV™, Nintendo®Wii™ or other game console, and/or TiVo®. These and other formats may be used to provide the slideshow to other devices having other platforms such as mobile phones, personal computing devices or other devices that may display multimedia content. In one embodiment, step 168 includes uploading the MP4, video, or podcast or other formatted slideshow to a server accessible by the desired devices 230 and 240. The formatted slideshow appropriate for the devices might be pushed to the desired device(s) 230 and 240 or pulled by the desired device(s) 230 or 240. Consequently, the slideshow is provided in the appropriate format for the platform of each of the desired device(s) on which the slideshow is to be played. The formatted slideshow may be shown on the display of the device, via step 170.

Thus, using the method 150 and system 200, a slideshow of a content may be automatically generated in the format(s) appropriate to multiple devices on which the slideshow is desired to be viewed. In one embodiment, one or more of the devices may be remote from the user's computer system and/or may belong to other individuals. This content may be obtained from the user's collection and/or a feed. In addition, the devices might not otherwise support displaying of particular types of content or content from the feed. For example, the slideshow may be provided to platforms such as iPods™, cell phones, computers, or other platforms that may or may not otherwise support slideshows, photo feeds, XML feeds, RSS feeds, or the like. Consequently, the users' ability to view and share their multimedia content is enhanced.

A method and system for providing a slideshow to multiple platforms has been disclosed. The present invention has been described in accordance with the embodiments shown, and one of ordinary skill in the art will readily recognize that there could be variations to the embodiments, and any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network.

We claim:

1. A computer-implemented method for displaying multimedia content on a device corresponding to a platform, the multimedia content including a plurality of items, the method comprising:
determining at least one attribute associated with an item of the plurality of items;
placing the item in a cluster based on the at least one attribute and without requiring user-selection of the item, the cluster including at least a portion of the plurality of items;
rendering a slideshow of the cluster as a formatted slideshow, the formatted slideshow corresponding to the platform; and
providing the formatted slideshow to the device for display.

2. The method of claim 1 wherein the providing the formatted slideshow further includes:
generating the slideshow of the cluster; and
formatting the slideshow to provide the formatted slideshow.

3. The method of claim 2 wherein the formatting further includes:
rendering the slideshow as a video.

4. The method of claim 2 wherein the formatting further includes:
generating a podcast of the slideshow.

5. The method of claim 1 wherein the plurality of items includes a plurality of photos.

6. The method of claim 5 wherein the plurality of items includes at least one video clip.

7. The method of claim 1 wherein the at least one attribute further includes at least one of user-added metadata, at least one temporal attribute, at least one geographic attribute, at least one subject attribute corresponding to at least one person in the item, at least one object of interest, at least one region of interest, at least one post-capture attribute, and at least one item quality attribute.

8. The method of claim 1 further comprising:
determining the platform.

9. The method of claim 1 further comprising:
receiving a first portion of the plurality of items from a feed.

10. The method of claim 9 wherein the feed includes an XML feed.

11. The method of claim 9 wherein the receiving further includes:
determining at least one location of the first portion of the plurality of items based on the feed; and
obtaining the first portion of the plurality of items from the at least one location.

12. The method of claim 9 further comprising:
separating the first portion of the plurality of items from the feed.

13. The method of claim 11 further comprising:
receiving a selection of the platform from the user.

14. The method of claim 1 further comprising:
receiving a request to share the cluster with at least one individual, each of the at least one individual corresponding to at least one platform; and
determining the at least one platform corresponding to each of the at least one individual, the at least one platform including the platform.

15. A computer-implemented method for displaying multimedia content on a device corresponding to a platform, the multimedia content including a plurality of items, the method comprising:
receiving a feed corresponding to at least a first portion of the plurality of items;
parsing each of the at least the first portion of the plurality of items based on the feed;
determining at least one attribute associated with each of the plurality of items;
placing a second portion of the plurality of items in a cluster based on the at least one attribute and without requiring user-selection of the second portion of the plurality of items;
generating a slideshow of the cluster;
rendering the slideshow of the cluster as a formatted slideshow, the formatted slideshow corresponding to the platform;
storing the formatted slideshow; and
providing the formatted slideshow to the device for display.

16. A system for displaying multimedia content on a device corresponding to a platform, the multimedia content including a plurality of items, the system comprising:
selection logic for determining at least one attribute associated with an item of the plurality of items and for placing the item in a cluster of at least a portion of the plurality of items based on the at least one attribute;
a rendering subsystem for rendering a slideshow of the cluster as a formatted slideshow, the formatted slideshow corresponding to the platform, the formatted slideshow being provided to the device for display.

17. The system of claim 16 further comprising:
slideshow logic for generating the slideshow.

18. The system of claim 17 wherein the rendering subsystem renders the slideshow as at least one of a video and a podcast.

19. The system of claim 16 wherein the plurality of items includes a plurality of photos.

20. The system of claim 16 further comprising:
a platform subsystem for determining the platform.

21. The system of claim 20 wherein the platform subsystem includes a database indicating at least one format corresponding to the platform.

22. The system of claim 16 wherein a first portion of the plurality of items is received from a feed.

23. The system of claim 22 further comprising:
logic coupled with selection logic for determining at least one location of the first portion of the plurality of items based on the feed; and
wherein the system obtains the first portion of the plurality of items from the at least one location.

24. The system of claim 23 wherein the selection logic further separates the first portion of the plurality of items from the feed.
